(19) United States
(12) Patent Application Publication
(10) Pub. No.: US 2013/0137534 A1
(43) Pub. Date: May 30, 2013

(54) RESIN COMPOSITION FOR GOLF BALL AND GOLF BALL

(71) Applicant: DUNLOP SPORTS CO. LTD., Kobe-shi (JP)

(72) Inventors: Kazuki SHIGA, Kobe-shi (JP); Ryo MURAKAMI, Kobe-shi (JP); Takahiro SHIGEMITSU, Kobe-shi (JP); Hideaki KIMURA, Kobe-shi (JP); Tomoka KITAGO, Kobe-shi (JP)

(73) Assignee: DUNLOP SPORTS CO. LTD., Kobe-shi (JP)

(21) Appl. No.: 13/686,191

(22) Filed: Nov. 27, 2012

(30) Foreign Application Priority Data
Nov. 29, 2011 (JP) 2011-260928
Apr. 18, 2012 (JP) 2012-094886

(51) Int. Cl. C08K 5/1535; C08K 5/103; C08L 33/02; A63B 37/00; C08L 33/08

(52) U.S. Cl. CPC C08K 5/1535; A63B 37/0051; A63B 37/007; C08L 33/08; C08L 33/02; C08K 5/103
USPC 473/372; 473/351; 473/385; 524/562; 524/556; 524/317; 524/58; 524/436

(57) ABSTRACT

Provided are a resin composition for a golf ball which is excellent in resilience, flexibility and fluidity, and a golf ball excellent in resilience and shot feeling. The present invention relates to a resin composition for a golf ball, including (A) a resin component and (B) a nonionic surfactant, the resin component (A) including at least one selected from the group consisting of (a-1) a binary copolymer of an olefin and a C₃₋₈ α,β-unsaturated carboxylic acid; (a-2) a metal ion-neutralized product of a binary copolymer of an olefin and a C₃₋₈ α,β-unsaturated carboxylic acid; (a-3) a ternary copolymer of an olefin, a C₃₋₈ α,β-unsaturated carboxylic acid, and an α,β-unsaturated carboxylic acid ester; and (a-4) a metal ion-neutralized product of a ternary copolymer of an olefin, a C₃₋₈ α,β-unsaturated carboxylic acid, and an α,β-unsaturated carboxylic acid ester.

### TECHNICAL FIELD

The present invention relates to a resin composition for a golf ball and a golf ball formed from the resin composition.

### BACKGROUND ART

Golf balls of various structures have been proposed such as one-piece golf balls consisting of a golf ball body; two-piece golf balls including a core and a cover; three-piece golf balls including a core that has a center and a single interlayer covering the center, and a cover covering the core; and multi-piece golf balls including a core that has a center and two or more interlayers covering the center, and a cover covering the core.

Widely used materials for golf balls are ionomer resins because ionomer resins provide golf balls which have high rigidity and which fly a long distance; in particular, highly resilient materials are desired. Ionomer resins with increased degrees of neutralization are known to enhance resilience. The highly neutralized ionomer resins, however, have low fluidity and poor moldability. Furthermore, although the increase in the degree of neutralization leads to enhanced resilience, it also tends to lead to increased hardness. This may cause reduced flexibility and a poor shot feeling.

In this respect, a method of decreasing the hardness while enhancing resilience is proposed. In this method, a large amount of a fatty acid (metallic soap) is added to a highly neutralized ionomer resin; however, the acid component in the fatty acid consumes metal ions used for neutralization, and therefore the effect of enhancing resilience due to the high degree of neutralization is not sufficiently achieved. Thus, the method is insufficient to ensure flexibility and enhance resilience in order to provide a golf ball that simultaneously achieves a good shot feeling and resilience. In addition, the method requires a large amount of the metal component.

Patent Literature 1 also discloses a golf ball using a polyhydric alcohol and an acid polymer in which at least 70% of acid groups are neutralized. Patent Literatures 2 and 3 disclose resin compositions for a golf ball which include an ionomer resin and a compound with a molecular weight of not more than 20,000 that contains two or more reactive functional groups. Patent Literature 4 teaches that fatty acid derivatives, such as alcohol fatty acid esters, glycerol fatty acid esters, and glycol fatty acid esters, may be added to a resin composition for a golf ball including a thermoplastic resin such as ternary ionomer.

These literatures, however, do not disclose the use of a predetermined amount of a polyhydric alcohol fatty acid ester, and there is still scope for improvement in simultaneous achievement of flexibility and enhanced resilience. Also, achieving good fluidity together with these properties is desired.

### CITATION LIST

### Patent Literature

Patent Literature 1: JP 2007-90048 A
Patent Literature 2: JP 2003-339911A
Patent Literature 3: JP 2004-180725 A
Patent Literature 4: JP 2001-348467 A

### SUMMARY OF INVENTION

### Technical Problem

The present invention aims to solve the above problems and provide a resin composition for a golf ball which is excellent in resilience, flexibility and fluidity. The present invention also aims to provide a golf ball excellent in resilience and shot feeling.

### Solution to Problem

The present invention relates to a resin composition for a golf ball, including: (A) a resin component, and (B) a nonionic surfactant, the resin component (A) including at least one selected from the group consisting of: (a-1) a binary copolymer of an olefin and a C₃₋₈ α,β-unsaturated carboxylic acid; (a-2) a metal ion-neutralized product of a binary copolymer of an olefin and a C₃₋₈ α,β-unsaturated carboxylic acid; (a-3) a ternary copolymer of an olefin, a C₃₋₈ α,β-unsaturated carboxylic acid, and an α,β-unsaturated carboxylic acid ester; and (a-4) a metal ion-neutralized product of a ternary copolymer of an olefin, a C₃₋₈ α,β-unsaturated carboxylic acid, and an α,β-unsaturated carboxylic acid ester.

Preferably, the nonionic surfactant is a polyhydric alcohol nonionic surfactant. Preferably, the nonionic surfactant is at least one selected from the group consisting of: fatty acid esters formed by reaction of polyhydric alcohols with fatty acids; AO adducts of the fatty acid esters formed by addition of alkylene oxides to the fatty acid esters; fatty acid alkanolamides formed by reaction of fatty acids with alkanolamines; and alkyl ethers of polyhydric alcohols. Preferably, the nonionic surfactant is a fatty acid ester formed by reaction of a polyhydric alcohol with a C₈₋₃₀ fatty acid. Here, suitably used as the fatty acid ester is a compound in which part of hydroxyl groups of the polyhydric alcohol is esterified.

Preferably, a fatty acid forming the polyhydric alcohol nonionic surfactant is an unsaturated fatty acid. Here, suitably used as the unsaturated fatty acid is at least one selected from the group consisting of oleic acid, linolic acid, linolenic acid, elaidic acid, stearolic acid, ricinoleic acid, ricinelaidic acid, and their branched isomers.

Preferably, the polyhydric alcohol is at least one selected from the group consisting of glycerol, polyglycerols, saccharides, and sugar alcohols.

The nonionic surfactant is particularly preferably at least one selected from the group consisting of glycerol monooleate, glycerol dioleate, sorbitan monooleate, sorbitan dioleate, sorbitan trioleate, sorbitan tetraoleate, and glycerol monostearate.

The resin composition for a golf ball preferably includes 10 to 200 parts by mass, and more preferably 20 to 200 parts by mass, of the nonionic surfactant for each 100 parts by mass of the resin component. Also, the resin composition for a golf ball preferably includes (C) a basic inorganic metal compound in an amount of 100 parts by mass or less for each 100 parts by mass of the resin component.

The basic inorganic metal compound (C) is preferably selected from the group consisting of magnesium hydroxide, calcium hydroxide, sodium carbonate, lithium carbonate, potassium carbonate, zinc oxide, and copper oxide.

The resin composition for a golf ball preferably has a total degree of neutralization of 20% or higher, the total degree of neutralization being defined by the following formula:

(Total degree of neutralization (%))=100×[(number of moles of cationic components in resin component (A))×(valence of cationic components)+(number of moles of metal components in basic inorganic metal compound (C))×(valence of metal components)]/[(number of moles of carboxyl groups in resin component (A)].

The present invention relates to a golf ball, including a member formed from the resin composition for a golf ball.

The present invention also relates to a golf ball, including a core having one or more layers, and a cover covering the core, wherein at least one of the layers of the core is formed from the resin composition for a golf ball.

The present invention still also relates to a one-piece golf ball, including a golf ball body formed from the resin composition for a golf ball.

### Advantageous Effects of Invention

In the present invention, a nonionic surfactant is added to a specific resin and therefore it is possible to suppress a reduction in resilience while ensuring flexibility and to reduce the melt viscosity to increase fluidity. Thus, the present invention provides a resin composition for a golf ball which is excellent in resilience, flexibility and fluidity. Accordingly, use of the resin composition enables to provide a golf ball excellent in resilience and shot feeling.

### BRIEF DESCRIPTION OF DRAWINGS

FIG. 1 is a graph showing the relationships between rebound resilience and Shore D hardness in examples and comparative examples of the present invention (binary ionomer resin).

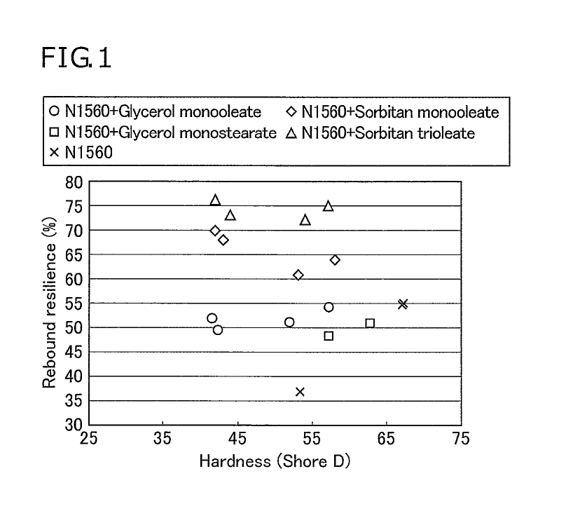

FIG. 2 is a graph showing the relationships between rebound resilience and Shore D hardness in examples and comparative examples of the present invention (ternary ionomer resin).

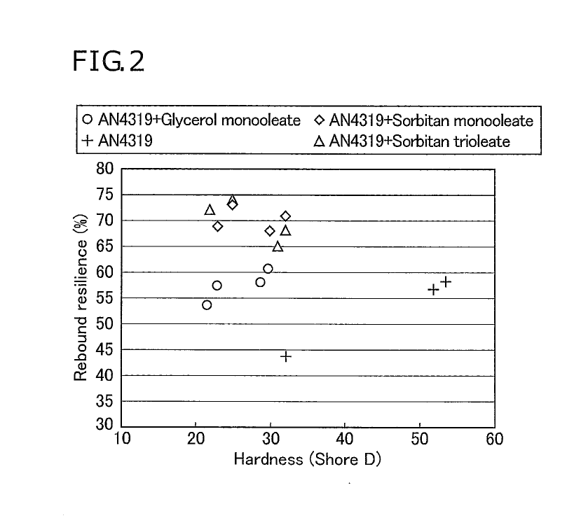

### DESCRIPTION OF EMBODIMENTS

The resin composition for a golf ball of the present invention includes (A) a resin component and (B) a nonionic surfactant, the resin component (A) including at least one selected from the group consisting of: (a-1) a binary copolymer of an olefin and a C₃₋₈ α,β-unsaturated carboxylic acid; (a-2) a metal ion-neutralized product of a binary copolymer of an olefin and a C₃₋₈ α,β-unsaturated carboxylic acid; (a-3) a ternary copolymer of an olefin, a C₃₋₈ α,β-unsaturated carboxylic acid, and an α,β-unsaturated carboxylic acid ester; and (a-4) a metal ion-neutralized product of a ternary copolymer of an olefin, a C₃₋₈ α,β-unsaturated carboxylic acid, and an α,β-unsaturated carboxylic acid ester.

As mentioned above, it is generally difficult to provide a golf ball material simultaneously having satisfactory resilience and flexibility by using a resin component such as ionomer resin. However, the addition of a nonionic surfactant to the resin component enables simultaneous achievement of flexibility and enhanced resilience, and therefore a golf ball excellent in resilience and shot feeling can be provided. The reason why such effects are produced is presumably as follows.

When a nonionic surfactant is added to an ionomer resin, the surfactant is thought to be involved into ionic aggregates of the ionomer resin and then serve to: (I) finely disperse the ionic aggregates and thereby inhibit crystallization of the ethylene chains; and to (II) loosen the restriction of main chains which is due to the ionic aggregates. Presumably, such effects lead to increased mobility of the molecular chains of the ionomer resin, and therefore both the flexibility and the resilience are simultaneously enhanced. In particular in the case of using a nonionic surfactant that contains as a hydrophobic group an unsaturated hydrocarbon group rather than a saturated hydrocarbon group, the effects of reducing the hardness and of enhancing resilience are significant. This is presumably because the effect of increasing the molecular mobility by inhibiting the crystallization works more efficiently.

Also in the case of using a nonionic surfactant, unlike the case of adding a fatty acid, the metal component is not consumed. Thus, the effect of enhancing resilience due to a high degree of neutralization can be sufficiently achieved without using a large amount of the metal component. Therefore, both the flexibility and the resilience are efficiently satisfied.

The use of a nonionic surfactant further enables reduction in the melt viscosity of the resin composition and improvement in fluidity. This is presumably because the crosslinking strength of the ionic aggregates is weakened since the electrostatic attraction between the surfactant and metal ions is weak.

First of all, the components (a-1) to (a-4) used as the resin component (A) in the present invention are described below.

The component (a-1) is a binary copolymer of an olefin and a C₃₋₈ α,β-unsaturated carboxylic acid, and it is a nonionic one in which the carboxyl groups of the copolymer are not neutralized. The component (a-2) is a metal ion-neutralized product of a binary copolymer of an olefin and a C₃₋₈ α,β-unsaturated carboxylic acid, and examples thereof include ionomer resins obtained by neutralizing at least part of the carboxyl groups of the copolymer with metal ions.

The component (a-3) is a ternary copolymer of an olefin, a C₃₋₈ α,β-unsaturated carboxylic acid, and an α,β-unsaturated carboxylic acid ester, and it is a nonionic one in which the carboxyl groups of the copolymer are not neutralized. The component (a-4) is a metal ion-neutralized product of a ternary copolymer of an olefin, a C₃₋₈ α,β-unsaturated carboxylic acid, and an α,β-unsaturated carboxylic acid ester, and examples thereof include ionomer resins obtained by neutralizing at least part of the carboxyl groups of the copolymer with metal ions.

In the present invention, the “binary copolymer (a-1) of an olefin and a C₃₋₈ α,β-unsaturated carboxylic acid” may also be referred to simply as the “binary copolymer”; the “ionomer resin consisting of (a-2) a metal ion-neutralized product of a binary copolymer of an olefin and a C₃₋₈ α,β-unsaturated carboxylic acid” as the “binary ionomer resin”; the “ternary copolymer (a-3) of an olefin, a C₃₋₈ α,β-unsaturated carboxylic acid, and an α,β-unsaturated carboxylic acid ester” simply as the “ternary copolymer”; and the “ionomer resin consisting of (a-4) a metal ion-neutralized product of a ternary copolymer of an olefin, a C₃₋₈ α,β-unsaturated carboxylic acid, and an α,β-unsaturated carboxylic acid ester” as the “ternary ionomer resin”.

In the components (a-1) to (a-4), the olefin is preferably a C₂₋₈ olefin, and examples thereof include ethylene, propylene, butene, pentene, hexene, heptene, and octene. Particularly preferred is ethylene. Examples of the C₃₋₈ α,β-unsaturated carboxylic acid include acrylic acid, methacrylic acid, fumaric acid, maleic acid, and crotonic acid, and particularly preferred is acrylic acid or methacrylic acid. Examples of the α,β-unsaturated carboxylic acid ester include methyl esters, ethyl esters, propyl esters, n-butyl esters, and isobutyl esters, of acrylic acid, methacrylic acid, fumaric acid, maleic acid and the like, and particularly preferred are acrylic acid esters and methacrylic acid esters.

The binary copolymer (a-1) is preferably a binary copolymer of ethylene and (meth) acrylic acid, and the binary ionomer resin (a-2) is preferably a metal ion-neutralized product of a binary copolymer of ethylene and (meth) acrylic acid. The ternary copolymer (a-3) is preferably a ternary copolymer of ethylene, (meth) acrylic acid, and a (meth) acrylic acid ester, and the ternary ionomer resin (a-4) is preferably a metal ion-neutralized product of a ternary copolymer of ethylene, (meth) acrylic acid, and a (meth) acrylic acid ester. The term “(meth) acrylic acid” herein means acrylic acid and/or methacrylic acid.

The amount of C₃₋₈ α,β-unsaturated carboxylic acid units in the binary copolymer (a-1) or the ternary copolymer (a-3) is preferably 4% by mass or more, and more preferably 5% by mass or more. The amount is also preferably 30% by mass or less, and more preferably 25% by mass or less.

The binary copolymer (a-1) or the ternary copolymer (a-3) preferably has a melt flow rate (190° C., 2.16 kg load) of 5 g/10 min or higher, more preferably 10 g/10 min or higher, and further preferably 15 g/10 min or higher. The melt flow rate is preferably 1700 g/10 min or lower, more preferably 1500 g/10 min or lower, and further preferably 1300 g/10 min or lower. When the melt flow rate is 5 g/10 min or higher, the resin composition for a golf ball has good fluidity, and therefore is easily molded into a member of a golf ball. When the melt flow rate is 1700 g/10 min or lower, a golf ball with better durability can be obtained.

Specific examples (indicated by trade name) of the binary copolymer (a-1) include ethylene-methacrylic acid copolymers available from DU PONT-MITSUI POLYCHEMICALS CO., LTD. under the trade name “NUCREL (registered trademark) (e.g. “NUCREL N 1050H”, “NUCREL N 2050H”, “NUCREL N 1110H”, “NUCREL N 0200H”, “NUCREL N 1560”)”, and an ethylene-acrylic acid copolymer available from The Dow Chemical Company under the trade name “PRIMACOR (registered trademark) 59801”.

Specific examples (indicated by trade name) of the ternary copolymer (a-3) include “NUCREL (registered trademark) (e.g. “NUCREL AN 4318”, “NUCREL AN 4319”)” available from DU PONT-MITSUI POLYCHEMICALS CO., LTD., “NUCREL (registered trademark) (e.g. “NUCREL AE”)” available from Du Pont, and “PRIMACOR (registered trademark) (e.g. “PRIMACOR AT 310”, “PRIMACOR AT 320”)” available from the Dow Chemical Company.

The binary copolymers (a-1) or the ternary copolymers (a-3) may be used alone, or two or more of these may be used in combination.

The amount of C₃₋₈ α,β-unsaturated carboxylic acid units in the binary ionomer resin (a-2) is preferably 8% by mass or more, more preferably 10% by mass or more, and further preferably 12% by mass or more. The amount is preferably 30% by mass or less, and more preferably 25% by mass or less. When the amount is 8% by mass or more, a member having desired resilience can be easily obtained. When the amount is 30% by mass or less, a member having moderate melt viscosity can be obtained, which indicates good moldability.

The degree of neutralization of carboxyl groups of the binary ionomer resin (a-2) is preferably 15 mol % or higher, and more preferably 20 mol % or higher. The degree of neutralization is preferably 90 mol % or lower, and more preferably 85 mol % or lower. When the degree is 15 mol % or higher, a golf ball having good resilience and durability can be obtained. Also, when the degree is 90 mol % or lower, the resin composition for a golf ball has good fluidity.

The degree of neutralization of carboxyl groups of the binary ionomer resin (a-2) can be determined by the following formula:

(Degree of neutralization of binary ionomer resin)=100×(number of moles of neutralized carboxyl groups in binary ionomer resin)/(total number of moles of carboxyl groups in binary ionomer resin before neutralization).

Examples of metal ions usable for neutralizing at least part of carboxyl groups in the binary ionomer resin (a-2) include: monovalent metal ions such as sodium, potassium, and lithium; bivalent metal ions such as magnesium, calcium, zinc, barium, and cadmium; trivalent metal ions such as aluminum; and other ions such as tin and zirconium.

Specific examples (indicated by trade name) of the binary ionomer resin (a-2) include “Himilan (registered trademark) (e.g. Himilan 1555 (Na), Himilan 1557 (Zn), Himilan 1605 (Na), Himilan 1706 (Zn), Himilan 1707 (Na), Himilan AM 7311 (Mg), Himilan AM 7329 (Zn))” available from DU PONT-MITSUI POLYCHEMICALS CO., LTD. Examples thereof further include “Surlyn (registered trademark) (e.g. Surlyn 8945 (Na), Surlyn 9945 (Zn), Surlyn 8140 (Na), Surlyn 8150 (Na), Surlyn 9120 (Zn), Surlyn 9150 (Zn), Surlyn 6910 (Mg), Surlyn 6120 (Mg), Surlyn 7930 (Li), Surlyn 7940 (Li), Surlyn AD 8546 (Li))” available from Du Pont. Other examples include ionomer resins available from ExxonMobil Chemical such as “Iotek (registered trademark) (e.g. Iotek 8000 (Na), Iotek 8030 (Na), Iotek 7010 (Zn), Iotek 7030 (Zn))”. The symbols such as Na, Zn, Li, and Mg in the parentheses following the trade names indicate metal species of the metal ions for neutralization. These examples of the binary ionomer resin (a-2) may be used alone, or two or more of these may be used as a blend.

The binary ionomer resin (a-2) preferably has a bending rigidity of 50 MPa or higher, more preferably 70 MPa or higher, and further preferably 80 MPa or higher. The bending rigidity is preferably 500 MPa or lower, more preferably 400 MPa or lower, and further preferably 350 MPa or lower. Too low a bending rigidity tends to lead to a golf ball with reduced resilience and therefore shorter flight distance; too high a bending rigidity may lead to a golf ball with reduced durability.

The binary ionomer resin (a-2) preferably has a melt flow rate (190° C., 2.16 kg load) of 0.1 g/10 min or higher, more preferably 0.5 g/10 min or higher, and further preferably 1.0 g/10 min or higher. The melt flow rate is preferably 80 g/10 min or lower, more preferably 70 g/10 min or lower, and further preferably 65 g/10 min or lower. When the melt flow rate is 0.1 g/10 min or higher, the resin composition for a golf ball has good fluidity and can be molded into, for example, a thin layer. When the melt flow rate is 80 g/10 min or lower, a golf ball with better durability can be obtained.

The binary ionomer resin (a-2) preferably has a slab hardness of 10 or higher, more preferably 15 or higher, and further preferably 20 or higher in Shore D hardness. The slab hardness (Shore D hardness) is also preferably 75 or lower, more preferably 73 or lower, and further preferably 70 or lower. When the slab hardness is 10 or higher, a member having good resilience can be obtained. When the slab hardness is 75 or lower, a member having moderate hardness and therefore a golf ball having better durability can be obtained.

The amount of C₃₋₈ α,β-unsaturated carboxylic acid units in the ternary ionomer resin (a-4) is preferably 2% by mass or more, and more preferably 3% by mass or more. The amount is preferably 30% by mass or less, and more preferably 25% by mass or less.

The degree of neutralization of carboxyl groups of the ternary ionomer resin (a-4) is preferably 20 mol % or higher, and more preferably 30 mol % or higher. The degree of neutralization is preferably 90 mol % or lower, and more preferably 85 mol % or lower. When the degree is 20 mol % or higher, a golf ball having good resilience and durability can be formed from the resin composition for a golf ball. When the degree is 90 mol % or lower, the resin composition for a golf ball has good fluidity.

The degree of neutralization of carboxyl groups of the ternary ionomer resin (a-4) can be determined by the following formula:

(Degree of neutralization of ternary ionomer resin)=100×(number of moles of neutralized carboxyl groups in ternary ionomer resin)/(total number of moles of carboxyl groups in ternary ionomer resin before neutralization).

Examples of metal ions usable for neutralizing at least part of carboxyl groups in the ternary ionomer resin (a-4) include those listed for the binary ionomer resin (a-2). The ternary ionomer resin (a-4) is preferably one neutralized by magnesium ions. Neutralization by magnesium ions leads to high rebound resilience.

Specific examples (indicated by trade name) of the ternary ionomer resin (a-4) include “Himilan (registered trademark) (e.g. Himilan AM 7327 (Zn), Himilan 1855 (Zn), Himilan 1856 (Na), Himilan AM 7331 (Na))” available from DU PONT-MITSUI POLYCHEMICALS CO., LTD. Other examples include ternary ionomer resins available from Du Pont such as “Surlyn 6320 (Mg), Surlyn 8120 (Na), Surlyn 8320 (Na), Surlyn 9320 (Zn), and Surlyn 9320W (Zn))”. Further examples include ternary ionomer resins available from ExxonMobil Chemical such as “Iotek 7510 (Zn) and Iotek 7520 (Zn)”. The symbols such as Na, Zn, and Mg in the parentheses following the trade names indicate metal species of the metal ions for neutralization. The ternary ionomer resins (a-4) may be used alone, or two or more of these may be used in combination.

The ternary ionomer resin (a-4) preferably has a bending rigidity of 10 MPa or higher, more preferably 11 MPa or higher, and further preferably 12 MPa or higher. The bending rigidity is preferably 100 MPa or lower, more preferably 97 MPa or lower, and further preferably 95 MPa or lower. Too low a bending rigidity tends to lead to a golf ball with reduced resilience and therefore shorter flight distance; too high a bending rigidity may lead to a golf ball with reduced durability.

The ternary ionomer resin (a-4) preferably has a melt flow rate (190° C., 2.16 kg load) of 0.1 g/10 min or higher, more preferably 0.3 g/10 min or higher, and further preferably 0.5 g/10 min or higher. The melt flow rate is preferably 70 g/10 min or lower, more preferably 60 g/10 min or lower, and further preferably 55 g/10 min or lower. When the melt flow rate is 0.1 g/10 min or higher, the resin composition for a golf ball has good fluidity and can be easily molded into a thin layer. When the melt flow rate is 70 g/10 min or lower, a golf ball with better durability can be obtained.

The ternary ionomer resin (a-4) preferably has a slab hardness of 1 or higher, more preferably 3 or higher, and further preferably 5 or higher in Shore D hardness. The slab hardness (Shore D hardness) is also preferably 70 or lower, more preferably 65 or lower, and further preferably 60 or lower. When the slab hardness is 1 or higher, a member having moderate softness and therefore a golf ball having good resilience can be obtained. When the slab hardness is 70 or lower, a member having moderate hardness and therefore a golf ball having better durability can be obtained.

The resin composition for a golf ball of the present invention preferably includes the ternary copolymer (a-3) or the ternary ionomer resin (a-4) as the resin component (A). In this case, a member having moderate hardness and high resilience can be obtained.

In preferred embodiments, the resin component of the resin composition for a golf ball of the present invention consists only of at least one selected from the aforementioned components (a-1) to (a-4). Still, the resin component may optionally include other thermoplastic elastomers and thermoplastic resins to the extent that they do not impair the effects of the present invention. If the resin component includes other thermoplastic elastomers and thermoplastic resins, the total amount of the components (a-1) to (a-4) is preferably 50% by mass or more, more preferably 60% by mass or more, and further preferably 70% by mass or more of the resin component.

Next, the nonionic surfactant (B) used in the present invention is described.

Nonionic surfactants usable in the present invention refer to surfactants containing a hydrophilic group that does not dissociate in water, such as a hydroxyl group (—OH) and an ether bond (—O—). Examples thereof include polyhydric alcohol nonionic surfactants, polyethylene glycol nonionic surfactants, perfluoroalkyl-polyoxyethylene ethers, and perfluoroalkenyl-polyoxyethylene ethers. Preferred among these are polyhydric alcohol nonionic surfactants and polyethylene glycol nonionic surfactants, and particularly preferred are polyhydric alcohol nonionic surfactants, from the viewpoint of being excellent in resilience, flexibility, and fluidity.

The polyhydric alcohol nonionic surfactants refer to nonionic surfactants formed by reaction of hydrophobic group-containing materials (e.g. fatty acids) with polyhydric alcohols which are hydrophilic group-containing materials (e.g. glycerol, polyglycerol, sorbitan). Examples thereof include: fatty acid esters formed by reaction of dihydric or higher hydric alcohols with fatty acids having about 5 to 36 carbon atoms; AO adducts of the fatty acid esters formed by addition of alkylene oxides (AO) such as ethylene oxide (EO) to the fatty acid esters; fatty acid alkanolamides formed by reaction of fatty acids with alkanolamines; and alkyl ethers of polyhydric alcohols. These fatty acid esters, AO adducts, fatty acid alkanolamides, and alkyl ethers may be those in which all the hydroxyl groups of the polyhydric alcohol or alkanolamine moiety are esterified or condensed, or may be those in which part of the hydroxyl groups are esterified or condensed (e.g. mono, di, tri, tetra). Preferred are those in which part of the hydroxyl groups are esterified or condensed. In the case of using AO adducts, the number of moles of AO added is 0.5 to 50, and preferably 0.5 to 30 on average per fatty acid ester molecule.

The carbon number of the fatty acid forming the polyhydric alcohol nonionic surfactant such as a fatty acid ester is preferably 8 to 30, more preferably 10 to 28, and further preferably 12 to 26, from the viewpoint of being excellent in resilience, flexibility, and fluidity. The fatty acid is suitably a straight-chain or branched fatty acid. Although both saturated and unsaturated fatty acids may be used, unsaturated fatty acids are preferred because they increase the molecular mobility by inhibiting the crystallization, and therefore they are more effective in reducing the hardness and enhancing resilience.

Examples of the fatty acid include fatty acids derived from natural fats and oils and synthetic fatty acids. Examples of the natural fatty acids include those derived from natural fats and oils such as palm oil, beef tallow, rapeseed oil, rice bran oil, and fish oil. Examples of the synthetic fatty acids include higher fatty acids having 5 to 36 carbon atoms. Specific examples thereof include saturated fatty acids such as caprylic acid, pelargonic acid, capric acid, undecanoic acid, lauric acid, tridecylic acid, myristic acid, pentadecylic acid, palmitic acid, margaric acid, stearic acid, nonadecylic acid, and arachidic acid, and their branched isomers; and unsaturated fatty acids such as oleic acid, erucic acid, linolic acid, linolenic acid, elaidic acid, stearolic acid, ricinoleic acid, ricinelaidic acid, arachidonic acid, vaccenic acid, myristoleic acid, and palmitoleic acid, and their branched isomers. Among these, preferred are unsaturated fatty acids such as oleic acid, erucic acid, linolic acid, linolenic acid, arachidonic acid, vaccenic acid, myristoleic acid, and palmitoleic acid, and particularly preferred is oleic acid, from the viewpoint of being excellent in resilience, flexibility, and fluidity.

Concerning the polyhydric alcohol forming the polyhydric alcohol nonionic surfactant, examples of usable dihydric alcohols include aliphatic, alicyclic, and aromatic dihydric alcohols having 2 or more carbon atoms. Specific examples thereof include (di)alkylene glycols (alkylene glycols and dialkylene glycols) such as (di) ethylene glycol, (di) propylene glycol, 1,2-, 1,3-, 2,3-, and -1,4-butanediol, neopentyl glycol, 3-methyl-1,5-pentanediol, 1,6-hexanediol, 2-methyl-1,8-octanediol, 1,9-nonanediol, and 1,12-dodecanediol; and cyclic group-containing low-molecular-weight diols, bis(hydroxymethyl)cyclohexane, and bis (hydroxyethyl) benzene. Examples of usable trihydric or higher hydric alcohols such as trihydric to octahydric alcohols include alkanepolyols (triols such as trimethylolpropane, glycerol, and hexanetriol; and tetrahydric or higher hydric alcohols such as pentaerythritol, sorbitol, xylitol, and mannitol), and their intermolecular or intramolecular dehydration products (polyglycerols such as diglycerol, dipentaerythritol, sorbitan, and the like), saccharides (glucose, fructose, sucrose, and the like), EO adducts of saccharides, fatty acid esters of EO adducts of saccharides, fatty acid esters of saccharides, sugar alcohols (alcohols formed by reduction of the aldehyde or ketone group of monosaccharides such as trioses, tetroses, pentoses, and hexoses, and specific examples thereof include: glycerol derived from triose; erithrite and threit which are derived from tetrose; arabite, ribitol, and xylit which are derived from pentose; sorbit, mannite, altritol, and galactitol which are derived from hexose), EO adducts of sugar alcohols, fatty acid esters of EO adducts of sugar alcohols, and fatty acid esters of sugar alcohols. Preferred among these are glycerol, polyglycerols, saccharides, and sugar alcohols, and particularly preferred is glycerol, from the viewpoint of being excellent in resilience, flexibility, and fluidity.

Examples of the alkanolamines forming the fatty acid alkanolamides include monoethanolamine, diethanolamine, triethanolamine, mono-n-propanolamine, di-n-propanolamine, tri-n-propanolamine, monoisopropanolamine, diisopropanolamine, triisopropanolamine, N-methylethanolamine, N-ethylethanolamine, N-isopropylethanolamine, N,N-dimethylethanolamine, N,N-diethylethanolamine, N-cyclohexyldiethanolamine, N-cyclohexyldipropanolamine, N-benzyldiethanolamine, and N-benzyldipropanolamine.

Specific examples of the polyhydric alcohol nonionic surfactant include glycerol monolaurate, glycerol monostearate, glycerol monooleate, glycerol dilaurate, glycerol distearate, glycerol dioleate, diglycerol monolaurate, diglycerol monostearate, diglycerol monooleate, pentaerythritol monolaurate, pentaerythritol monostearate, pentaerythritol monooleate, pentaerythritol dilaurate, pentaerythritol distearate, pentaerythritol dioleate, sorbitan monolaurate, sorbitan monostearate, sorbitan monooleate, sorbitan dilaurate, sorbitan distearate, sorbitan dioleate, sorbitan trilaurate, sorbitan tristearate, sorbitan trioleate, sorbitan tetralaurate, sorbitan tetrastearate, and sorbitan tetraoleate. Preferred among these are glycerol monooleate, glycerol dioleate, sorbitan monooleate, sorbitan dioleate, sorbitan trioleate, and sorbitan tetraoleate, from the viewpoint of being excellent in resilience, flexibility, and fluidity. One of these polyhydric alcohol nonionic surfactants may be used alone, or two or more of them may be used in combination.

The polyethylene glycol nonionic surfactants refer to nonionic surfactants formed by addition of ethylene oxide to hydrophobic group-containing materials for surfactants, such as higher alcohols and fatty acids. Although the alkyl or alkenyl groups of the hydrophobic group-containing materials are not particularly limited, preferred are alkyl and alkenyl groups having 12 to 18 carbon atoms. The number of moles of ethylene oxide added is preferably 2 to 40 though it depends on the species of the hydrophobic group attached.

Examples of the polyethylene glycol nonionic surfactants include higher alcohol-ethylene oxide adducts and alkylphenol-ethylene oxide adducts. Specific examples thereof include polyoxyethylene lauryl ether, polyoxyethylene stearyl ether, polyoxyethylene oleyl ether, and polyoxyethylene octylphenol. One of these polyethylene glycol nonionic surfactants may be used alone, or two or more of them may be used in combination.

The amount of the nonionic surfactant (B) is preferably 10 parts by mass or more, more preferably 20 parts by mass or more, further preferably 25 parts by mass or more, and particularly preferably 30 parts by mass or more, for each 100 parts by mass of the resin component. The amount is preferably 200 parts by mass or less, more preferably 150 parts by mass or less, further preferably 120 parts by mass or less, and particularly preferably 100 parts by mass or less. When the amount is in the range, the resilience and flexibility can be improved in a balanced manner.

The resin composition for a golf ball of the present invention may further include (C) a basic inorganic metal compound. The basic inorganic metal compound (C) is added as appropriate in order to neutralize unneutralized carboxyl groups in the component (A). Examples of the basic inorganic metal compound (C) include elemental metals such as sodium, lithium, potassium, calcium, and magnesium; metal hydroxides such as magnesium hydroxide, calcium hydroxide, sodium hydroxide, lithium hydroxide, potassium hydroxide, and copper hydroxide; metal oxides such as magnesium oxide, calcium oxide, zinc oxide, and copper oxide; and metal carbonates such as magnesium carbonate, calcium carbonate, sodium carbonate, lithium carbonate, and potassium carbonate. Each of these basic inorganic metal compounds (C) may be used alone, or two or more of these may be used in combination. Among these, suitable as the basic inorganic metal compound (C) are magnesium hydroxide, calcium hydroxide, sodium carbonate, lithium carbonate, potassium carbonate, zinc oxide, and copper oxide.

The amount of the basic inorganic metal compound (C) is preferably more than 0 parts by mass, and is more preferably 1 part by mass or more, for each 100 parts by mass of the resin component. The amount is preferably 100 parts by mass or less, and more preferably 70 parts by mass or less. If the amount is too small, the amount of ionic aggregates may be too small, resulting in low resilience. Conversely, if the amount is too large, the durability may be poor.

The resin composition for a golf ball of the present invention preferably has a total degree of neutralization defined by the following formula of 20% or higher, more preferably 40% or higher, and further preferably 60% or higher. The total degree of neutralization is preferably 1000% or lower, more preferably 800% or lower, and further preferably 600% or lower. When the total degree is 20% or higher, the amount of ionic aggregates is sufficiently large, resulting in high resilience. When the total degree is 1000% or lower, the basic inorganic metal compound can be uniformly dispersed to enhance durability.

The total degree of neutralization is defined by the following formula:

(Total degree of neutralization (%))=100×[(number of moles of cationic components in resin component (A))×(valence of cationic components)+(number of moles of metal components in basic inorganic metal compound (C))×(valence of metal components)]/[(number of moles of carboxyl groups in resin component (A)].

Here, the numbers of moles of cationic components, of metal components, and of carboxyl groups include the respective non-ionized precursors. The amount of cationic components may be determined by, for example, neutralization titration.

The resin composition for a golf ball of the present invention may further include any additives such as pigments including white pigments (e.g. titanium oxide) and blue pigments, weighting agents, dispersants, antioxidants, ultraviolet absorbents, light stabilizers, fluorescent materials, and fluorescent brighteners as long as the performance of the golf ball is not impaired. Furthermore, the resin composition for a golf ball of the present invention may further include, for example, a fatty acid and/or a metal salt thereof as long as the effects of the present invention are not impaired.

The amount of the white pigment (e.g. titanium oxide) is preferably 0.5 parts by mass or more, and more preferably 1 part by mass or more, for each 100 parts by mass of the resin component. The amount is preferably 10 parts by mass or less, and more preferably 8 parts by mass or less. When the amount is 0.5 parts by mass or more, it is possible to impart hiding properties to a golf ball member to be obtained. If the amount exceeds 10 parts by mass, a golf ball with poor durability may be obtained.

The resin composition for a golf ball of the present invention may be prepared, for example, by dry-blending the component (A) and the component (B), and optionally the component (C). The dry-blended mixture may be extruded into pellets. The dry-blending is preferably performed using, for example, a mixer that can mix pelletized materials, and more preferably by a tumbler mixer. The extrusion may be performed using a known extruder such as a single-screw extruder, a twin-screw extruder, or a twin-screw/single-screw extruder.

The resin composition for a golf ball of the present invention preferably has a spin-lattice relaxation time of ¹³C nuclei (T1) measured by high-resolution solid-state ¹³C nuclear magnetic resonance (NMR) spectroscopy of 15 seconds or shorter. When the decay of magnetization is measured in an ionomer resin based on the spin-lattice relaxation time of ¹³C nuclei (T1) measured by high-resolution solid-state ¹³C nuclear magnetic resonance (NMR) spectroscopy, this relaxation time (T1) is considered to be attributable to the trans conformation of the ethylene chains. The present inventors have considered that the moieties that may have a trans conformation include the poly (ethylene)) crystals and the restricted ethylene chain layer around each ionic aggregate, and thus the relaxation components in the measurement of the decay of magnetization can also be divided into the short-time component and the long-time component. Based on the consideration, they have found that the restricted ethylene chain layer correlates with the resilience. In other words, the shorter the relaxation time (T1) is, the higher the mobility of the restricted ethylene chain layer is, and in turn the more enhanced the resilience is. Further, an increase in the molecular mobility is expected to cause an effect of enhancing flexibility. Therefore, the resin composition for a golf ball of the present invention preferably has a spin-lattice relaxation time of ¹³C nuclei (T1) measured by high-resolution solid-state ¹³C nuclear magnetic resonance (NMR) spectroscopy as short as described above.

The resin composition for a golf ball of the present invention preferably has a storage modulus E′ (Pa) and a loss modulus E″ (Pa) which satisfy the following formula, as measured using a dynamic viscoelasticity meter in a tensile mode under the conditions: vibration frequency 10 Hz, temperature 12° C., and measurement strain 0.05%.

A resin composition for a golf ball satisfying the following formula can have high resilience while maintaining softness in a high level. In the following formula, the symbol “log” means the common logarithm.

log(E′/E″²)≧−6.55

It is considered that the higher the storage modulus E′ (Pa) is or the lower the loss modulus E″ (Pa) is, the higher the resilience is. In addition, the higher the storage modulus E′ (Pa) is, the higher the hardness is. In the above formula, the numerator is the first power of the storage modulus E′, whereas the denominator is the second power of the loss modulus E″. This means that for enhancement of resilience, it is more effective to reduce the loss modulus E″ than to increase the storage modulus E′ so as to increase the hardness. In other words, what is necessary to enhance resilience without hardening the material is considered to reduce the modulus E″ to reduce the energy loss upon deformation. In the present invention, it is considered that since an increase in the molecular mobility as described above enables the material to be smoothly deformed against a stress, the energy loss is small and the resilience is enhanced.

The upper limit of log(E′/E″²) is not particularly limited, but it is preferably −5.24 or lower, and more preferably −5.40 or lower because if the value of log(E′/E″²) comes to −5.25, the coefficient of restitution becomes close to the maximum value of 1. The reason why the measurement of dynamic viscoelasticity is performed under the conditions: vibration frequency 10 Hz and temperature 12° C. is as follows. The period of contact between a golf ball and an impact bar (metal cylinder) is 500 μs in the measurement of coefficient of restitution at 40 m/s. If this contact is assumed to correspond to deformation in one cycle, this deformation corresponds to deformation at a frequency of several thousand hertz. Based on the frequency-temperature superposition principle of general ionomer resin, the dynamic viscoelasticity measured under the conditions: room temperature and vibration frequency of several thousand hertz corresponds to the dynamic viscoelasticity measured under the conditions: temperature 12° C. and vibration frequency 10 Hz.

The resin composition for a golf ball of the present invention preferably has a melt flow rate (190° C., 2.16 kg) of 0.01 g/10 min or higher, more preferably 1 g/10 min or higher, and further preferably 10 g/10 min or higher. The melt flow rate is preferably 150 g/10 min or lower, more preferably 100 g/10 min or lower, and further preferably 80 g/10 min or lower. When the melt flow rate is in the range, the composition can be favorably molded into a golf ball member.

The resin composition for a golf ball preferably has a rebound resilience of 40% or higher, more preferably 43% or higher, and further preferably 46% or higher. The resin composition for a golf ball with a rebound resilience of 40% or higher enables to provide a golf ball with excellent resilience (flight distance). The rebound resilience herein is a rebound resilience measured after the resin composition for a golf ball is formed into a sheet, and is measured by the method mentioned later.

The resin composition for a golf ball preferably has a slab hardness of 5 or higher, more preferably 7 or higher, and further preferably 10 or higher in Shore D hardness. The slab hardness (Shore D hardness) is preferably 70 or lower, more preferably 65 or lower, further preferably 60 or lower, and most preferably 50 or lower. The resin composition for a golf ball with a slab hardness of 5 or higher enables to provide a golf ball with excellent resilience (flight distance). Conversely, the resin composition for a golf ball with a slab hardness of 70 or lower enables to provide a golf ball with excellent durability. The slab hardness of the resin composition for a golf ball herein is a hardness measured after the resin composition for a golf ball is formed into a sheet, and is measured by the method mentioned later.

The golf ball of the present invention is not particularly limited as long as it includes a member formed from the resin composition for a golf ball. Examples thereof include one-piece golf balls; two-piece golf balls having a monolayer core and a cover disposed so as to cover the monolayer core; three-piece golf balls having a core that has a center and a single interlayer disposed so as to cover the center, and a cover disposed so as to cover the core; and multi-piece golf balls (including the three-piece golf balls) having a core that has a center and one or more interlayers disposed so as to cover the center, and a cover disposed so as to cover the core, provided that any of the members of each golf ball is formed from the resin composition for a golf ball of the present invention. Preferred among these are: golf balls having a core that has one or more layers and a cover covering the core, wherein at least one of the layers of the core is formed from the resin composition for a golf ball; and one-piece golf balls having a golf ball body formed from the resin composition for a golf ball. Particularly preferred are: two-piece golf balls having a monolayer core and a cover disposed so as to cover the monolayer core, wherein the monolayer core is formed from the resin composition for a golf ball; and multi-piece golf balls having a core that has a center and one or more interlayers disposed so as to cover the center, and a cover disposed so as to cover the core, wherein the center is formed from the resin composition for a golf ball.

The following will describe one example of the golf ball of the present invention based on, but not limited to, one embodiment of a two-piece golf ball having a core and a cover disposed so as to cover the core, wherein the core is formed from the aforementioned resin composition for a golf ball.

The core may be formed by, for example, injection-molding the resin composition for a golf ball mentioned above. Specifically, it is preferable that the resin composition for a golf ball is heat-melted at 160° C. to 260° C. and injected into a mold that is clamped under a pressure of 1 to 100 MPa in 1 to 100 seconds, and then the resin composition is cooled for 30 to 300 seconds and finally the mold is opened.

The shape of the core is preferably a spherical shape. If the core is not spherical, the cover may have a non-uniform thickness, thereby resulting in its portion having poor covering performance.

The diameter of the core is preferably 39.00 mm or greater, more preferably 39.25 mm or greater, and further preferably 39.50 mm or greater. The diameter is preferably 42.37 mm or smaller, more preferably 42.22 mm or smaller, and further preferably 42.07 mm or smaller. When the diameter is 39.00 mm or greater, the cover layer has a moderate thickness, resulting in good resilience. Also, when the diameter is 42.37 mm or smaller, the cover layer has a moderate thinness, thereby allowing the cover to provide sufficient protection.

In the case that the core has a diameter of 39.00 to 42.37 mm, the amount of compression deformation (shrink in the compression direction) of the core under a load from an initial load of 98 N to a final load of 1275 N is preferably 1.00 mm or greater, and more preferably 1.10 mm or greater. The amount of compression deformation is preferably 5.00 mm or smaller, more preferably 4.90 mm or smaller, and further preferably 4.80 mm or smaller. When the amount of compression deformation is 1.00 mm or greater, a good shot feeling will be obtained. When the amount of compression deformation is 5.00 mm or smaller, good resilience is achieved.

The surface hardness of the core is preferably 20 or higher, more preferably 25 or higher, and further preferably 30 or higher in Shore D hardness. The surface hardness (Shore D hardness) is preferably 70 or lower, and more preferably 69 or lower. When the surface hardness is 20 or higher, the core has moderate softness, and good resilience is achieved. Also, when the surface hardness is 70 or lower, the core has moderate hardness, and a good shot feeling will be obtained.

The central hardness of the core is preferably 5 or higher, more preferably 7 or higher, and further preferably 10 or higher in Shore D hardness. If the central hardness is lower than 5, the core may be too soft, resulting in reduced resilience. The central hardness of the core is also preferably 50 or lower, more preferably 48 or lower, and further preferably 46 or lower in Shore D hardness. If the central hardness exceeds 50, the core tends to be too hard, leading to a poor shot feeling. In the present invention, the central hardness of the core means a hardness measured as follows: the core is cut into two equal parts, and the part is measured at the central point of the cut plane using a spring type Shore D hardness tester.

The core may preferably include a filler. A filler is mainly intended to be added as a weighting agent for adjusting the density of a golf ball to be obtained as the final product in the range of 1.0 to 1.5, and it may be added if necessary. Examples of the filler include inorganic fillers such as zinc oxide, barium sulfate, calcium carbonate, magnesium oxide, tungsten powder, and molybdenum powder. The amount of the filler is preferably 0.5 parts by mass or more, and more preferably 1.0 part by mass or more, for each 100 parts by mass of the resin component. The amount is preferably 30 parts by mass or less, and more preferably 20 parts by mass or less. If the amount of the filler is less than 0.5 parts by mass, it tends to be difficult to adjust the weight. If the amount exceeds 30 parts by mass, the weight fraction of the resin component may be small and the resilience tends to be reduced.

The cover of the golf ball of the present invention is preferably formed from a cover composition containing a resin component. Examples of resins that may be contained in the resin component include various resins such as ionomer resins, polyester resins, urethane resins (e.g. thermoplastic urethane resins, two-pack curable urethane resins), and polyamide resins; thermoplastic polyamide elastomers available from Arkema under the trade name “Pebax (registered trademark) (e.g. “Pebax 2533”)”; thermoplastic polyester elastomers available from DU PONT-TORAY CO., LTD. under the trade name “Hytrel (registered trademark) (e.g. “Hytrel 3548”, “Hytrel 4047”)”; thermoplastic polyurethane elastomers available from BASF Japan Ltd. under the trade name “Elastollan (registered trademark) (e.g. “Elastollan XNY 97A”)”; and thermoplastic styrene elastomers available from Mitsubishi Chemical Corp. under the trade name “RABALON (registered trademark)”. Each of these resins may be used alone, or two or more of these may be used as a blend.

Preferred examples of ionomer resins usable for the cover of the golf ball include those listed for the component (a-2) and the component (a-4).

The cover composition used for the cover of the golf ball more preferably contains a polyurethane resin (including a polyurethane elastomer) or an ionomer resin as the resin component. The amount of the polyurethane resin or the ionomer resin is preferably 50% by mass or more, more preferably 60% by mass or more, and further preferably 70% by mass or more of the resin component of the cover composition.

In addition to the resin component, the cover composition may contain any additives such as pigments such as white pigments (e.g. titanium oxide), blue pigments, and red pigments, zinc oxide, weighting agents such as calcium carbonate and barium sulfate, dispersants, antioxidants, ultraviolet absorbents, light stabilizers, fluorescent materials, and fluorescent brighteners, to the extent that they do not impair the performance of the cover.

The amount of the white pigment (e.g. titanium oxide) is preferably 0.5 parts by mass or more, and more preferably 1 part by mass or more, for each 100 parts by mass of the resin component used for the cover. The amount is preferably 10 parts by mass or less, and more preferably 8 parts by mass or less. When the amount of the white pigment is 0.5 parts by mass or more, it is possible to impart hiding properties to the cover. If the amount exceeds 10 parts by mass, a cover with poor durability may be obtained.

Examples of the method for forming the cover of the golf ball of the present invention include: compression molding in which hollow shells are formed from the cover composition, a core is covered with the plurality of shells, and then the assembly is compression-molded (preferably, hollow half shells are formed from the cover composition, a core is covered with the two half shells, and then the assembly is compression-molded); and injection molding in which the cover composition is directly injection-molded on a core.

In the case of forming a cover by injection molding of the cover composition, a pelletized cover composition, which is prepared by extrusion in advance, may be injection-molded, or materials for a cover such as a base resin component and a pigment may be dry-blended and then directly injection-molded. Upper and lower molds for forming a cover each preferably have a hemispherical cavity with pimples a part of which also serve as retractable hold pins. A cover can be formed by injection molding as follows: the hold pins are protruded; a core is put into the mold and held by the pins; then, the cover composition is injected thereon and cooled. More specifically, it is preferable that the mold is clamped under a pressure of 9 to 15 MPa, the cover composition heated to 200° C. to 250° C. is injected into the mold in 0.5 to 5 seconds, and then the composition is cooled for 10 to 60 seconds and the mold is opened.

In forming a cover, indentations called dimples are formed on the surface, in general. The cover preferably has 200 to 500 dimples in total. If the total number of dimples is less than 200, the effect of dimples is less likely to be achieved. Conversely, if the total number of dimples exceeds 500, the effect of dimples is less likely to be achieved because the individual size of the dimples is small. The shape (in a plan view) of each dimple to be formed is not particularly limited, and examples thereof include a circular shape; polygonal shapes such as a substantially triangular shape, substantially quadrangular shape, substantially pentagonal shape, and substantially hexagonal shape; and other irregular shapes. Each of these shapes may be employed alone, or two or more shapes may be employed in combination.

The thickness of the cover is preferably 2.0 mm or smaller, more preferably 1.6 mm or smaller, further preferably 1.2 mm or smaller, and particularly preferably 1.0 mm or smaller. When the thickness is 2.0 mm or smaller, the resulting golf ball can achieve better resilience and shot feeling. The thickness of the cover is preferably 0.1 mm or greater, more preferably 0.2 mm or greater, and further preferably 0.3 mm or greater. If the thickness is smaller than 0.1 mm, the cover may be difficult to form by molding, and the durability and abrasion resistance of the cover may be poor.

After the cover is formed, the golf ball body is taken out of the mold, and is preferably subjected to surface treatment such as deburring, cleaning, and sandblasting, as necessary. If desired, a paint layer or a mark may be formed thereon. The thickness of the paint layer is not particularly limited, but it is preferably 5 μm or greater, and more preferably 7 μm or greater. The thickness is preferably 25 μm or smaller, and more preferably 18 μm or smaller. If the thickness is smaller than 5 μm, the paint layer may easily disappear by abrasion after continuous use. If the thickness exceeds 25 μm, the effect of dimples is likely to be reduced, resulting in reduction of the flying performance of the golf ball.

The golf ball of the present invention preferably has an amount of compression deformation (shrink in the compression direction) under a load from an initial load of 98 N to a final load of 1275 N of 2.0 mm or greater, and more preferably 2.2 mm or greater. The amount of compression deformation is preferably 4.0 mm or smaller, and more preferably 3.5 mm or smaller. The golf ball with an amount of compression deformation of 2.0 mm or greater has moderate hardness and gives a good shot feeling. Also, the golf ball with an amount of compression deformation of 4.0 mm or smaller has high resilience.

Hereinbefore, the embodiment in which the resin composition for a golf ball of the present invention is used for a core is described. The resin composition for a golf ball of the present invention can also be used for centers, interlayers, and covers. In the case of a center formed from the resin composition for a golf ball of the present invention, an interlayer is combined which is formed from materials such as those listed above as the resin component for the cover.

### EXAMPLES

The present invention will be described in greater detail referring to, but not limited to, examples.

### [Evaluation Methods]

### (1) Slab Hardness (Shore D Hardness)

The resin composition for a golf ball was hot press-molded into a sheet having a thickness of about 2 mm, and the sheet was stored at 23° C. for 2 weeks. Three or more pieces of the sheet were stacked on one another so as not to be affected by the measurement substrate and the like, and the slab hardness of the stack was measured using a P1-series auto rubber hardness tester (from KOBUNSHI KEIKI CO., LTD.) including a spring type Shore D hardness tester in conformity with ASTM-D 2240.

(2) Melt Flow Rate (MFR) (g/10 Min)

The MFR was measured using a flow tester (Shimadzu Flowtester CFT-100C manufactured by Shimadzu Corp.) in conformity with JIS K 7210. The measurement was performed at a measurement temperature of 190° C. and a load of 2.16 kg.

### (3) Rebound Resilience (%)

The resin composition for a golf ball was hot press-molded into a sheet with a thickness of about 2 mm, and then circular pieces having a diameter of 28 mm were punched out of this sheet. Six pieces were stacked to prepare a cylindrical specimen with a thickness of about 12 mm and a diameter of 28 mm. This specimen was subjected to the Lupke rebound resilience test (testing at temperature 23° C. and humidity 50 RH %). The specimen preparation and the testing method were in conformity with JIS K 6255.

### (4) Amount of Compression Deformation

A spherical body was compressed under a load from an initial load of 98 N to a final load of 1275 N, and the amount of deformation in the compression direction (shrink in the compression direction) of the spherical body was measured. The amounts of deformation of balls are shown relative to the amount of deformation of the ball No. 15 in Table 1, or the amount of deformation of the ball No. 30 in Table 2.

### (5) Coefficient of Restitution

A 198.4-g metal cylinder was allowed to collide with each spherical body at a speed of 40 m/s. The speeds of the cylinder and the golf ball before and after the collision were measured. Based on these speeds and weights, the coefficient of restitution of each golf ball was calculated. The measurement was conducted by using twelve spherical bodies of each kind, and their average value was treated as the coefficient of restitution for the kind of spherical body in question.

### (6) Shot Feeling

Each golf ball was subjected to a hitting test by 10 amateur (advanced) golfers using a driver, and the golfers evaluated the ball for the feeling upon hitting it based on the following criteria. The most common grade among the grades given by the 10 golfers was treated as the shot feeling of the golf ball.

### Criteria for Grades

Excellent: small impact and good feeling

Good: ordinary levels

Poor: large impact and poor feeling

### (7) Method of Measuring Spin-Lattice Relaxation Time of ¹³C Nuclei (T1) by High-Resolution Solid-State ¹³C Nuclear Magnetic Resonance (NMR) Spectroscopy

Device: Bruker Avance 400

Measurement method: T1 relaxation time measurement by Torchia method

Measurement frequency: 100.6256207 MHz

Measurement temperature: room temperature

Standard substance: adamantane

Magic angle spinning rate: 5000 Hz

Pulse width: 4.80 μsec
Contact time: 2000 μsec

Pulse interval: 1 μsec, 100 msec, 500 msec, 1 sec, 2 sec, 3 sec, 4 sec, 6 sec, 8 sec, 10 sec, 12 sec, 15 sec, 20 sec, 40 sec, 80 sec, and 120 sec

Magnetic field strength: 9.4 T

### (8) Measurement of Storage Modulus E′ (Pa) and Loss Modulus E″(Pa)

The storage modulus E′ (Pa) and loss modulus E″ (Pa) of the resin composition for a golf ball were measured under the following conditions.

Device: dynamic viscoelasticity meter Rheogel-E 4000 (available from UBM)

Measurement sample: a 4-mm-wide specimen (distance between clamps: 20 mm) cut out of a 2-mm-thick sheet that was prepared by press-molding the resin composition for a golf ball

Measurement mode: Tensile

Measurement temperature: 12° C.

Vibration frequency: 10 Hz

Measurement strain: 0.05%

### [Preparation of Spherical Body (Core)]

As shown in Table 1 or 2, the materials for composition were dry-blended and mixed using a twin-screw kneading extruder. Then, the mixture was extruded into cold water to form a strand. The extruded strand was cut into pellets using a pelletizer, whereby a pelletized resin composition for a golf ball was prepared. Here, the extrusion was performed at a screw diameter of 45 mm, a screw rotation rate of 200 rpm, and a screw L/D ratio of 35. The mixture was heated to 160° C. to 230° C. in the die of the extruder. The pelletized resin composition for a golf ball obtained was injection-molded at 220° C., and thereby a spherical body (core) with a diameter of 40 mm was obtained.

TABLE 1
Binary ionomer resin

| Resin composition for golf ball | | Example | | | | | | | | |
|---|---|---|---|---|---|---|---|---|---|---|
| (spherical body) No. | | 1 | 2 | 3 | 4 | 5 | 6 | 7 | 8 | 9 |
| Composition | NUCREL N1560 | 100.0 | 100.0 | 100.0 | 100.0 | 100.0 | 100.0 | 100.0 | 100.0 | 100.0 |
| | Magnesium hydroxide | 2.7 | 3.8 | 2.7 | 3.8 | 3.8 | 3.8 | 2.7 | 3.8 | 2.7 |
| | Glycerol monooleate | 30.0 | 30.0 | 70.0 | 70.0 | — | — | — | — | — |
| | Glycerol monostearate | — | — | — | — | 30.0 | 70.0 | — | — | — |
| | Sorbitan monooleate | — | — | — | — | — | — | 30.0 | 30.0 | 70.0 |
| | Sorbitan trioleate | — | — | — | — | — | — | — | — | — |
| Physical | Total degree of | 27% | 37% | 27% | 37% | 37% | 37% | 27% | 37% | 27% |
| properties | neutralization (%) | | | | | | | | | |
| | Melt flow rate (g/10 min) | 54.1 | 45.3 | >60.0 | >60.0 | 41.5 | >60.0 | 56.3 | 49.6 | >60.0 |
| | Shore D hardness | 52 | 57 | 42 | 41 | 63 | 57 | 53 | 58 | 43 |
| | Rebound resilience (%) | 51 | 54 | 50 | 52 | 51 | 49 | 61 | 64 | 68 |
| | bg (E′/E″²) | −6.27 | −6.15 | −6.33 | −6.24 | −6.27 | −6.37 | −5.90 | −5.79 | −5.64 |
| | T1 relaxation time (sec) | 10.9 | 9.1 | 12.1 | 10.4 | 11.0 | 12.9 | 6.1 | 5.0 | 3.9 |
| | Amount of compression | 1.06 | 0.85 | 1.73 | 1.80 | 0.68 | 0.84 | 1.01 | 0.81 | 1.66 |
| | deformation | | | | | | | | | |
| | Coefficient of restitution | 0.677 | 0.709 | 0.659 | 0.685 | 0.676 | 0.648 | 0.778 | 0.809 | 0.851 |
| | Shot feeling | Good | Good | Excellent | Excellent | Good | Good | Good | Good | Excellent |

| Resin composition for golf ball | | Example | | | | | Comparative Example | | |
|---|---|---|---|---|---|---|---|---|---|
| (spherical body) No. | | 10 | 11 | 12 | 13 | 14 | 15 | 16 | 17 |
| Composition | NUCREL N1560 | 100.0 | 100.0 | 100.0 | 100.0 | 100.0 | 100.0 | 100.0 | 100.0 |
| | Magnesium hydroxide | 3.8 | 2.7 | 3.8 | 2.7 | 3.8 | — | 2.7 | 3.8 |
| | Glycerol monooleate | — | — | — | — | — | — | — | — |
| | Glycerol monostearate | — | — | — | — | — | — | — | — |
| | Sorbitan monooleate | 70.0 | — | — | — | — | — | — | — |
| | Sorbitan trioleate | — | 30.0 | 30.0 | 70.0 | 70.0 | — | — | — |
| Physical | Total degree of | 37% | 27% | 37% | 27% | 37% | 0% | 27% | 37% |
| properties | neutralization (%) | | | | | | | | |
| | Melt flow rate (g/10 min) | >60.0 | 57.1 | 50.3 | >60.0 | >60.0 | 58.5 | 6.8 | 3.1 |
| | Shore D hardness | 42 | 54 | 57 | 44 | 42 | 53 | 67 | 67 |
| | Rebound resilience (%) | 70 | 72 | 75 | 73 | 76 | 37 | 55 | 55 |
| | bg (E′/E″²) | −5.56 | −5.48 | −5.37 | −5.45 | −5.33 | −6.81 | −6.12 | −6.13 |
| | T1 relaxation time (sec) | 3.5 | 3.1 | 2.6 | 2.9 | 2.4 | 24.0 | 8.7 | 8.8 |
| | Amount of compression | 1.75 | 0.96 | 0.85 | 1.57 | 1.75 | 1.00 | 0.57 | 0.58 |
| | deformation | | | | | | | | |
| | Coefficient of restitution | 0.873 | 0.894 | 0.925 | 0.904 | 0.936 | 0.449 | 0.716 | 0.714 |
| | Shot feeling | Excellent | Good | Good | Excellent | Excellent | Good | Poor | Poor |

Composition: parts by mass

TABLE 2
Ternary ionomer resin

| Resin composition for golf ball | | Example | | | | | | | |
|---|---|---|---|---|---|---|---|---|---|
| (spherical body) No. | | 18 | 19 | 20 | 21 | 22 | 23 | 24 | 25 |
| Composition | NUCREL AN4319 | 100.0 | 100.0 | 100.0 | 100.0 | 100.0 | 100.0 | 100.0 | 100.0 |
| | Magnesium hydroxide | 7.2 | 10.5 | 7.2 | 10.5 | 7.2 | 10.5 | 7.2 | 10.5 |
| | Glycerol monooleate | 70.0 | 70.0 | 100.0 | 100.0 | — | — | — | — |
| | Glycerol monostearate | — | — | — | — | — | — | — | — |
| | Sorbitan monooleate | — | — | — | — | 70.0 | 70.0 | 100.0 | 100.0 |
| | Sorbitan trioleate | — | — | — | — | — | — | — | — |
| Physical | Total degree of | 264% | 389% | 264% | 389% | 264% | 389% | 264% | 389% |
| properties | neutralization (%) | | | | | | | | |
| | Melt flow rate (g/10 min) | 54.1 | 45.3 | >60.0 | >60.0 | 56.3 | 47.7 | >60.0 | >60.0 |
| | Shore D hardness | 29 | 30 | 22 | 23 | 30 | 32 | 23 | 25 |
| | Rebound resilience (%) | 58 | 61 | 54 | 58 | 68 | 71 | 69 | 73 |
| | bg (E′/E″²) | −6.00 | −5.91 | −6.18 | −6.03 | −5.64 | −5.52 | −5.60 | −5.45 |
| | T1 relaxation time (sec) | 7.1 | 6.1 | 9.4 | 7.4 | 3.9 | 3.3 | 3.7 | 2.9 |
| | Amount of compression | 1.31 | 1.20 | 2.57 | 2.23 | 1.17 | 1.00 | 2.20 | 1.80 |
| | deformation | | | | | | | | |
| | Coefficient of restitution | 0.749 | 0.777 | 0.702 | 0.742 | 0.851 | 0.883 | 0.862 | 0.904 |
| | Shot feeling | Excellent | Excellent | Excellent | Excellent | Excellent | Excellent | Excellent | Excellent |

| Resin composition for golf ball | | Example | | | | Comparative Example | | |
|---|---|---|---|---|---|---|---|---|
| (spherical body) No. | | 26 | 27 | 28 | 29 | 30 | 31 | 32 |
| Composition | NUCREL AN4319 | 100.0 | 100.0 | 100.0 | 100.0 | 100.0 | 100.0 | 100.0 |
| | Magnesium hydroxide | 7.2 | 10.5 | 7.2 | 10.5 | — | 2.7 | 3.8 |
| | Glycerol monooleate | — | — | — | — | — | — | — |
| | Glycerol monostearate | — | — | — | — | — | — | — |
| | Sorbitan monooleate | — | — | — | — | — | — | — |
| | Sorbitan trioleate | 70.0 | 70.0 | 100.0 | 100.0 | — | — | — |
| Physical | Total degree of | 264% | 389% | 264% | 389% | 0% | 100% | 140% |
| properties | neutralization (%) | | | | | | | |
| | Melt flow rate (g/10 min) | 57.2 | 48.8 | >60.0 | >60.0 | 55.0 | 6.8 | 3.1 |
| | Shore D hardness | 31 | 32 | 22 | 25 | 32 | 52 | 54 |
| | Rebound resilience (%) | 65 | 68 | 72 | 74 | 44 | 57 | 59 |
| | bg (E′/E″²) | −5.75 | −5.64 | −5.48 | −5.41 | −6.55 | −6.05 | −6.00 |
| | T1 relaxation time (sec) | 4.7 | 3.9 | 3.1 | 2.7 | 24.0 | 7.7 | 7.1 |
| | Amount of compression | 1.08 | 1.00 | 2.44 | 1.80 | 1.00 | 0.32 | 0.29 |
| | deformation | | | | | | | |
| | Coefficient of restitution | 0.820 | 0.851 | 0.894 | 0.915 | 0.449 | 0.736 | 0.751 |
| | Shot feeling | Excellent | Excellent | Excellent | Excellent | Excellent | Good | Good |

Composition: parts by mass

The materials shown in Tables 1 and 2 are as follows.

NUCREL AN4319: ethylene/methacrylic acid/butyl acrylate copolymer (DU PONT-MITSUI POLYCHEMICALS CO., LTD., melt flow rate (190° C., 2.16 kg): 55 g/10 min, bending rigidity: 21 MPa, methacrylic acid content: 8% by mass)

NUCREL N1560: ethylene/methacrylic acid copolymer (DU PONT-MITSUI POLYCHEMICALS CO., LTD., melt flow rate (190° C., 2.16 kg): 60 g/10 min, bending rigidity: 83 MPa, methacrylic acid content: 15% by mass)

Magnesium hydroxide: product of Wako Pure Chemical Industries, Ltd.

Glycerol monooleate (oleic acid monoglyceride): “Rikemal OL-100E” (Riken Vitamin Co., Ltd.)

Glycerol monostearate (stearic acid monoglyceride): “Rikemal S-100” (Riken Vitamin Co., Ltd.)

Sorbitan monooleate: “Poem 0-80V” (Riken Vitamin Co., Ltd.)

Sorbitan trioleate: “Rikemal OR-85” (Riken Vitamin Co., Ltd.)

Table 1 shows that in comparison with the spherical bodies Nos. 15 to 17 containing a binary ionomer resin, the spherical bodies Nos. 1 to 14 further containing glycerol monooleate, glycerol monostearate, sorbitan monooleate, or sorbitan trioleate with the resin exhibited both enhanced resilience and greatly improved fluidity while the materials had flexibility. Table 2 also shows that similar effects were remarkably produced in the spherical bodies Nos. 18 to 29 with a ternary ionomer resin. In particular, the spherical bodies further containing sorbitan monooleate or sorbitan trioleate were more effective in enhancing resilience while ensuring flexibility. These results demonstrate that the addition of such a nonionic surfactant enables to give good moldability in production and to provide a golf ball excellent in both shot feeling and resilience.

### INDUSTRIAL APPLICABILITY

The present invention can provide a resin composition for a golf ball which is excellent in resilience, flexibility, and fluidity, and the resin composition can provide a golf ball excellent in resilience and shot feeling.

1. A resin composition for a golf ball, comprising
(A) a resin component, and
(B) a nonionic surfactant,
the resin component (A) comprising at least one selected from the group consisting of:
(a-1) a binary copolymer of an olefin and a C₃₋₈ α,β-unsaturated carboxylic acid;
(a-2) a metal ion-neutralized product of a binary copolymer of an olefin and a C₃₋₈ α,β-unsaturated carboxylic acid;
(a-3) a ternary copolymer of an olefin, a C₃₋₈ α,β-unsaturated carboxylic acid, and an α,β-unsaturated carboxylic acid ester; and
(a-4) a metal ion-neutralized product of a ternary copolymer of an olefin, a C₃₋₈ α,β-unsaturated carboxylic acid, and an α,β-unsaturated carboxylic acid ester.

2. The resin composition for a golf ball according to claim 1,
wherein the nonionic surfactant is a polyhydric alcohol nonionic surfactant.

3. The resin composition for a golf ball according to claim 1,
wherein the nonionic surfactant is at least one selected from the group consisting of:
fatty acid esters formed by reaction of polyhydric alcohols with fatty acids,
AO adducts of the fatty acid esters formed by addition of alkylene oxides to the fatty acid esters,
fatty acid alkanolamides formed by reaction of fatty acids with alkanolamines, and
alkyl ethers of polyhydric alcohols.

4. The resin composition for a golf ball according to claim 1,
wherein the nonionic surfactant is a fatty acid ester formed by reaction of a polyhydric alcohol with a C₈₋₃₀ fatty acid.

5. The resin composition for a golf ball according to claim 4,
wherein the fatty acid ester is a compound in which part of hydroxyl groups of the polyhydric alcohol is esterified.

6. The resin composition for a golf ball according to claim 2,
wherein a fatty acid forming the polyhydric alcohol nonionic surfactant is an unsaturated fatty acid.

7. The resin composition for a golf ball according to claim 6,
wherein the unsaturated fatty acid is at least one selected from the group consisting of oleic acid, linolic acid, linolenic acid, elaidic acid, stearolic acid, ricinoleic acid, ricinelaidic acid, and their branched isomers.

8. The resin composition for a golf ball according to claim 2,
wherein the polyhydric alcohol is at least one selected from the group consisting of glycerol, polyglycerols, saccharides, and sugar alcohols.

9. The resin composition for a golf ball according to claim 1,
wherein the nonionic surfactant is at least one selected from the group consisting of glycerol monooleate, glycerol dioleate, sorbitan monooleate, sorbitan dioleate, sorbitan trioleate, sorbitan tetraoleate, and glycerol monostearate.

10. The resin composition for a golf ball according to claim 1,
wherein the resin composition comprises 10 to 200 parts by mass of the nonionic surfactant for each 100 parts by mass of the resin component.

11. The resin composition for a golf ball according to claim 1,
wherein the resin composition comprises 20 to 200 parts by mass of the nonionic surfactant for each 100 parts by mass of the resin component.

12. The resin composition for a golf ball according to claim 1,
wherein the resin composition comprises (C) a basic inorganic metal compound in an amount of 100 parts by mass or less for each 100 parts by mass of the resin component.

13. The resin composition for a golf ball according to claim 12,
wherein the basic inorganic metal compound (C) is selected from the group consisting of magnesium hydroxide, calcium hydroxide, sodium carbonate, lithium carbonate, potassium carbonate, zinc oxide, and copper oxide.

14. The resin composition for a golf ball according to claim 1,
wherein the resin composition has a total degree of neutralization of 20% or higher, the total degree of neutralization being defined by the following formula:
(Total degree of neutralization (%))=100×[(number of moles of cationic components in resin component (A))×(valence of cationic components)+(number of moles of metal components in basic inorganic metal compound (C))×(valence of metal components)]/[(number of moles of carboxyl groups in resin component (A)].

15. A golf ball, comprising a member formed from the resin composition for a golf ball according to claim 1.

16. A golf ball, comprising a core having one or more layers, and a cover covering the core,
wherein at least one of the layers of the core is formed from the resin composition for a golf ball according to claim 1.

17. A one-piece golf ball, comprising a golf ball body formed from the resin composition for a golf ball according to claim 1.
